(19) United States
(12) Patent Application Publication
(10) Pub. No.: US 2005/0276154 A1
(43) Pub. Date: Dec. 15, 2005

(54) Method and apparatus for mixing a masonry composition

(76) Inventor: Robert E. Dunlap, Indianapolis, IN (US)

Correspondence Address: BAKER & DANIELS LLP, 300 NORTH MERIDIAN STREET, SUITE 2700, INDIANAPOLIS, IN, 46204, US

(21) Appl. No.: 11/129,527

(22) Filed: May 12, 2005

Related U.S. Application Data
(60) Provisional application No. 60/584,121, filed on Jun. 11, 2004.

(51) Int. Cl. B28C 5/02

(52) U.S. Cl. 366/6; 366/130

(57) ABSTRACT

An apparatus for mixing a dry mix masonry component and a liquid component to produce a masonry composition is disclosed along with associated methods of using the apparatus. A method may include providing a flexible container having an opening for receiving the dry mix component and the liquid component and for removing the mixed masonry composition.

This application claims the benefit of U.S. Provisional Patent Application Ser. No. 60/584,121, filed Jun. 11, 2004, the disclosure of which is expressly incorporated by reference herein.

### BACKGROUND AND SUMMARY OF THE INVENTION

The present invention pertains to methods and apparatus to mix a dry mix with a liquid component, and in particular, a dry masonry mix, such as cement, mortar, or grout with a liquid component such as water.

According to an exemplary embodiment of the invention, an apparatus is provided, the apparatus including a flexible container having an opening for receiving a dry mix masonry component and a liquid component and for removing a masonry composition and a binding member for substantially closing the opening. In one example, the flexible container includes at least one handle to aid in the agitation of the dry mix masonry component and the liquid component and to aid in the removal of the masonry component from the interior of the flexible container.

In a further exemplary embodiment of the present invention, a method of mixing a dry mix masonry component and a liquid component to produce a masonry composition is provided. The method comprising the steps of: providing a flexible container having an interior, an exterior, and an opening sized to receive the dry mix masonry component and the liquid component; placing the dry mix masonry component and the liquid component into the interior of the flexible container through the opening, the dry mix masonry component and the liquid component being able to mix together; substantially closing the opening of the flexible container to retain the dry mix masonry component and the liquid component within the interior of the flexible container; agitating the dry mix masonry component and the liquid component to produce the masonry composition from the dry mix masonry component and the liquid component; and opening the opening of the flexible container to permit the removal of the masonry composition from the interior of the flexible container. In one example, the step of placing the dry mix masonry component and the liquid component into the interior of the flexible container through the opening comprises the steps of: standing a prepackaged bag containing the dry mix masonry component on end and opening at least a portion of a top of the bag; introducing the opened top of the bag into the interior of the flexible container through the opening of the flexible container; inverting the combination of the flexible container and the bag so that the dry mix masonry component exits the bag leaving an empty bag; removing the empty bag from the interior of the flexible container; and placing the liquid component into the interior of the flexible container.

In another exemplary embodiment of the present invention, a method of producing multiple batches of a masonry composition, each batch produced by mixing a dry mix masonry component and a liquid component is provided. The method comprising the steps of: providing a reusable flexible container having an open end; producing a first batch of masonry composition from a first dry mix masonry component and a first liquid component including the steps of: placing the first dry mix masonry component and the first liquid component into an interior of the flexible container through the open end of the flexible container; substantially closing the open end of the flexible container; agitating the first dry mix component and the first liquid component to produce the first batch of masonry composition; and opening the open end of the flexible container to permit the removal of the first batch of masonry composition from the interior of the flexible container; and producing a second batch of masonry composition generally directly following the removal of the first batch of masonry composition from the flexible container, the second batch of masonry composition being produced from a second dry mix masonry component and a second liquid component including the steps of: placing the second dry mix masonry component and the second liquid component into the interior of the flexible container through the open end; substantially closing the open end of the flexible container; agitating the second dry mix component and the second liquid component to produce the second batch of masonry composition; and opening the open end of the flexible container to permit the removal of the second batch of masonry composition from the interior of the flexible container. In one example, the step of placing the respective dry mix masonry component of the first and second dry mix masonry components and the respective liquid component of the first and second liquid components into the interior of the flexible container through the opening comprises the steps of: standing a prepackaged bag containing the respective dry mix masonry component on end and opening at least a portion of a top of the bag; introducing the opened top of the bag into the interior of the flexible container through the opening of the flexible container; inverting the combination of the flexible container and the bag so that the respective dry mix masonry component exits the bag leaving an empty bag; removing the empty bag from the interior of the flexible container; and placing the respective liquid component into the interior of the flexible container.

In yet a further exemplary embodiment of the present invention, a method for promoting the sale of masonry related products is provided. The method comprising the steps of: positioning a plurality of prepackaged dry mix masonry bags at a first display location, each of the prepackaged dry mix masonry bags containing a dry mix masonry component being configured to produce a masonry composition when thoroughly mixed with a liquid component; positioning at a second display location proximate to the first display location, a plurality of prepackaged mixing apparatus configured for use with the dry mix masonry component of the prepackaged dry mix masonry bags, each prepackaged mixing apparatus including an empty flexible container having an open end and a binding member and each prepackaged mixing apparatus being configured to produce a batch of masonry composition. In one example, each of the prepackaged mixing apparatus are configured to produce a batch of masonry composition by: receiving through the open end of the flexible container into an interior of the flexible container at least a portion of the dry mix masonry component of one of the prepackaged dry mix masonry bags and a corresponding amount of the liquid component; substantially closing the open end of the flexible container with the binding member; mixing the dry mix masonry component and the liquid component within the flexible container to produce a first batch of the masonry composition; and removing the binding member to permit the removal of the masonry composition from the flexible container. In one variation of the example, the step of receiving through the open end of the flexible container into an interior of the flexible container at least a portion of the dry mix masonry component of one of the prepackaged dry mix masonry bags and a corresponding amount of the liquid component comprises the steps of: standing the prepackaged dry mix masonry bag on end and opening at least a portion of a top of the bag; introducing the opened top of the bag into the interior of the flexible container through the open end of the flexible container; inverting the combination of the flexible container and the bag such that the dry mix masonry component exits the bag leaving an empty bag; removing the empty bag from the interior of the flexible container; and placing the corresponding amount of the liquid component into the interior of the flexible container.

Additional features of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The detailed description of the drawings particularly refers to the accompanying figures in which:

FIG. 1 is a exemplary apparatus for mixing a dry mix masonry component and a liquid component to produce a masonry composition, the apparatus including a flexible container and a binding member;

FIG. 2 is a first exemplary method of mixing the dry mix masonry component and the liquid component to produce the masonry composition;

FIG. 3 is a second exemplary method of mixing the dry mix masonry component and the liquid component to produce the building composition, the second exemplary method being illustrated with the preparation of a cement composition;

FIG. 4 shows a top portion of a bag of dry cement mix being received by an opening of the flexible container of FIG. 1;

FIG. 5 shows the bag of dry mix cement and the flexible container of FIG. 4 being inverted so that the dry mix cement component is placed in the interior of the flexible container;

FIG. 6 shows the introduction of the liquid component into the interior the flexible container;

FIG. 7 shows the gathering of the top portion of the flexible container proximate to the opening;

FIG. 8 shows the application of the binding member of FIG. 1 to the gathered portion of FIG. 7 to substantially close the flexible container;

FIG. 9 shows one method of mixing the dry mix component and the liquid component on the ground to produce the cement composition;

FIG. 10 shows the pouring of the cement composition from the interior of the flexible container to a desired location, illustratively a hole;

FIG. 11 shows a first exemplary packaging for the flexible container and the binding member;

FIG. 12 shows a second exemplary packaging for a plurality of flexible containers and one or more binding members, the flexible containers are attached to together as a single sheet and are rolled onto a roller;

FIG. 13 shows a plurality of the packaging of FIG. 11 attached to a clip strip holder, the clip strip holder being positioned proximate to a plurality of bags of dry mix component;

FIG. 14 shows a plurality of the packaging of FIG. 11 placed in a display pack or holder, the display pack and holder being positioned proximate to a plurality of bags of dry mix component;

FIG. 15 is a front view of a second embodiment of a flexible container; and

FIG. 16 is a front view of a third embodiment of a flexible container.

### DETAILED DESCRIPTION OF THE DRAWINGS

While this invention has been shown and described as having multiple designs, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

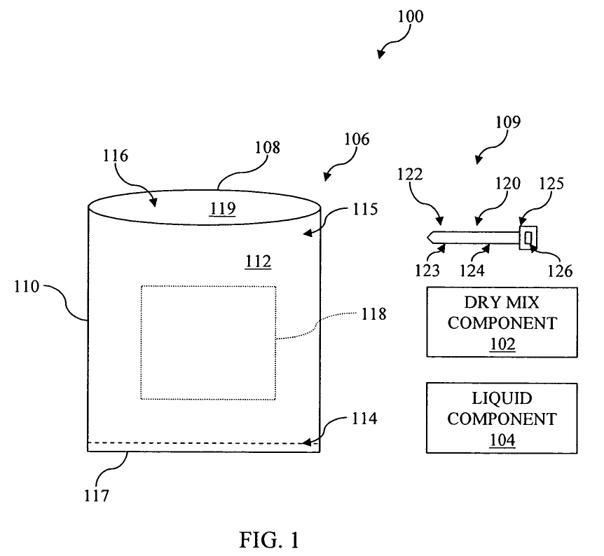

Referring to FIG. 1, an apparatus 100 for facilitating the mixing of a dry mix masonry component 102 and a liquid component 104 is shown. Apparatus 100 includes a flexible container 106 having an opening 108 for receiving dry mix masonry component 102, such as cement mix, and liquid component 104, such as water, and a binding member 109.

Flexible container 106 is flexible to permit the agitation of materials placed therein from the exterior of flexible container 106 as discussed in more detail herein. Further, flexible container 106 is flexible to permit the collapsing of flexible container 106 for easy storage as discussed in more detail herein.

Flexible container 106 is illustratively shown as a bag 110. Bag 110 is formed from a generally cylindrical wall 112 of flexible material, such as a plastic bag. In one example, bag 110 is made from polyethylene plastic. Alternatively, bag 110 may be made from any clear flexible plastic polymer.

A bottom portion 114 of cylindrical wall 112 is sealed together so that an interior 116 of bag 110 is able to hold materials placed therein. The seal is represented by a dashed line in FIG. 1. In one example, bottom portion 114 is sealed about 0.5 inches from a lower edge 117 of bag 110. In alternative embodiments, bag 110 has a bottom surface instead of a sealed edge.

Once bottom portion 114 is sealed, interior 116 of bag 110 has a single compartment for holding materials therein. As explained herein, the dry mix masonry component 102 and the liquid component 104 are received through opening 108 into the single compartment of interior 116 and the resultant masonry composition is removed from the single compartment of interior 116 through opening 108.

The size and thickness of bag 110 may be tailored to the type and quantity of masonry compositions being produced from dry mix component 102 and liquid component 104. Exemplary masonry dry components 102 include dry cement mix, dry mortar mix, and dry tile grout mix. At least some of the exemplary masonry components are available in prepackaged bags of various sizes. For example, dry cement mix is typically available in one or more of the following sizes of prepackaged bags: 10 pounds, 20 pounds, 40 pounds, 50 pounds, 60 pounds, and 80 pounds. In one embodiment, bag 110 is sized for mixing batches of cement composition (40 to 80 pound dry mix bags) and is about 22 inches wide and about 34 inches tall. As such, bag 110 may be used to mix a full 80 pound bag of dry cement mix at one time. In another embodiment, bag 110 is sized for mixing tile composition or small batches of cement composition (10 to 20 pound dry mix bags) and is about 18 inches wide and about 24 inches tall.

In the preferred embodiment, the thickness of bag 110 is chosen such that bag 110 permits easy storage (when not in use) and proper mixing of dry mix component 102 and liquid component 104. In one embodiment, bag 110 is at least about 0.004 inches thick. In another embodiment, bag 110 is at least about 0.006 inches thick. In a further embodiment, bag 110 is about 0.007 inches thick. In still a further embodiment, bag 110 is between about 0.004 inches thick to about 0.007 inches thick.

In one embodiment, bag 110 is made of a clear or semi-transparent flexible material to permit a user to observe the mixing of the materials from the exterior of bag 110. This permits the user to see the mixing process and to verify that a complete and thorough mix of the dry mix masonry component and the liquid component is produced for every batch. In an alternative embodiment, bag 110 is made of a colored or opaque material.

Cylindrical wall 112 of bag 110 includes at least one portion 118 whereupon indicia are printed or otherwise located. Exemplary indicia includes trademark information, contact information, directions for use of apparatus 100 such as exemplary methods 200 or 300, and warnings, such as suffocation warnings.

In one embodiment, the surface of interior 116 of bag 110 is coated with a slickening agent. Slickening agents are known in the art. In one embodiment, a 250 ppm oleamide slickening agent is used. The slickening agent eases the opening of bag 110 by reducing static and permits materials within bag 110 to move easier relative to an interior surface 119 of bag 110. This aids in the mixing of the masonry composition and in the removal of the masonry composition from bag 110.

In the preferred embodiment, binding member 109 is illustratively shown as a hook and loop type tie 120. Tie 120 includes a strap 122 and a buckle 125. Strap 122 includes on one side a first region 123 having hook features and a second region 124 having loop features. Buckle 125 includes an aperture 126 sized to receive strap 122. In use, tie 120 is positioned around a gathered portion of flexible container 106 and strap 122 is inserted through aperture 126 of buckle 125. The inserted portion of strap 122 is then doubled back so that it overlaps the remaining portion of strap 122 and pulled tight against buckle 125. Once tightened the hook features of the inserted portion of strap 122 interact with the loop features of the remaining portion to secure tie 120. Other exemplary binding members 109 include a plastic closure strap, twist ties, garbage bag ties, bands, rope, or other suitable binding members that may at least substantially close opening 108.

Flexible container 106 may be used as a disposable product that does not require any cleanup. Once all or a desired portion of the resultant masonry composition is removed from interior 116, flexible container 106 may be discarded. Alternatively, flexible container 106 may be reused to mix several batches of masonry composition either successively or at spaced apart intervals of time, such as days, with proper cleaning. Surface 119 of interior 116 should be generally smooth to aid in expelling of the resultant masonry composition and in the cleaning of interior 116, if desired. In one example, interior 116 may be cleaned by spraying interior 116 with water or another liquid. It should be understood that interior 116 of flexible container 106 does not require cleaning between each batch of masonry composition as long as the subsequent batch is made within a reasonable amount of time so that any residue from the previous batch has not set or hardened.

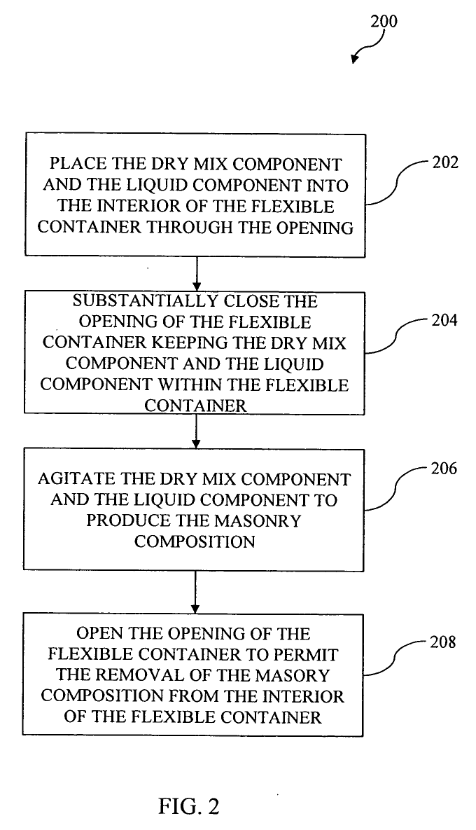

A first exemplary method 200 of mixing dry mix component 102 and liquid component 104 is shown in FIG. 2. As represented by block 202, dry mix component 102 and liquid component 104 are each placed into the interior of flexible container 106 through opening 108. The order of adding dry mix component 102 and liquid component 104 is not important, although it is easier to add dry mix component 102 prior to the addition of liquid component 104 because dry mix component shapes flexible container 106 such that flexible container 106 will stand.

As represented by block 204, opening 108 of flexible container 106 is substantially closed to retain dry mix component 102 and liquid component 104 within flexible container 106. Opening 108 may be substantially closed by gathering a top portion 115 of flexible container 106 together and holding it with a binding member, gathering top portion 115 of flexible container 106 together and twisting the gathered portion, or by gathering top portion 115 of flexible container 106 together, twisting the gathered portion, and securing it with a binding member.

As represented by block 206, the dry mix component and the liquid component are thoroughly mixed to produce the masonry composition. It should be understood that dry mix component 102 and liquid component 104 are at least partially mixed when they both are positioned within interior 116. In one embodiment, the thorough mixing of dry mix component 102 and liquid component 104 is accomplished by agitating components 102, 104 from the exterior of flexible container 106. Exemplary methods of agitation include kneading the components 102, 104 from the exterior of flexible container 106, rolling flexible container 106 including components 102, 104 in interior 116 on the ground or other surface, rolling flexible container 106 including components 102, 104 in interior 116 on the ground in a back and forth fashion “rock and roll movement,” and/or shaking flexible container 106 including components 102, 104 up and down. In the case of an 80 pound bag of dry mix cement agitated by the “rock and roll movement,” the resultant thoroughly mixed cement component may be produced in less than one minute of agitation time. In one example, the agitation time should be about 30 seconds.

It should be noted that by mixing dry mix component 102 and liquid component 104 inside a substantially closed container, none of individual components 102 and 104 or slurry formed from components 102, 104 is spilled or splashed onto unintended areas. As such, the substantially closed flexible container 106 minimizes mess during mixing and protects the integrity of the surrounding region.

Once components 102, 104 are thoroughly mixed, opening 108 of flexible container 106 is opened to permit the removal of the resultant masonry composition from interior 116 of flexible container 106, as represented by block 208. In one embodiment, top portion 115 of flexible container 106 is positioned proximate to the location that the masonry composition is to be applied prior to the opening of opening 108. As such, the resultant masonry composition may be slid out of flexible container 106 without ever having to physically lift the whole resultant masonry composition as typically done with a bucket or wheelbarrow mixing arrangement and without spilling the resultant masonry composition onto the surrounding area. In one example, the masonry composition is slid out of flexible container 106 by lifting up on bottom portion 114 of flexible container 106 to move the resultant masonry composition to top portion 115 and eventually out of flexible container 106.

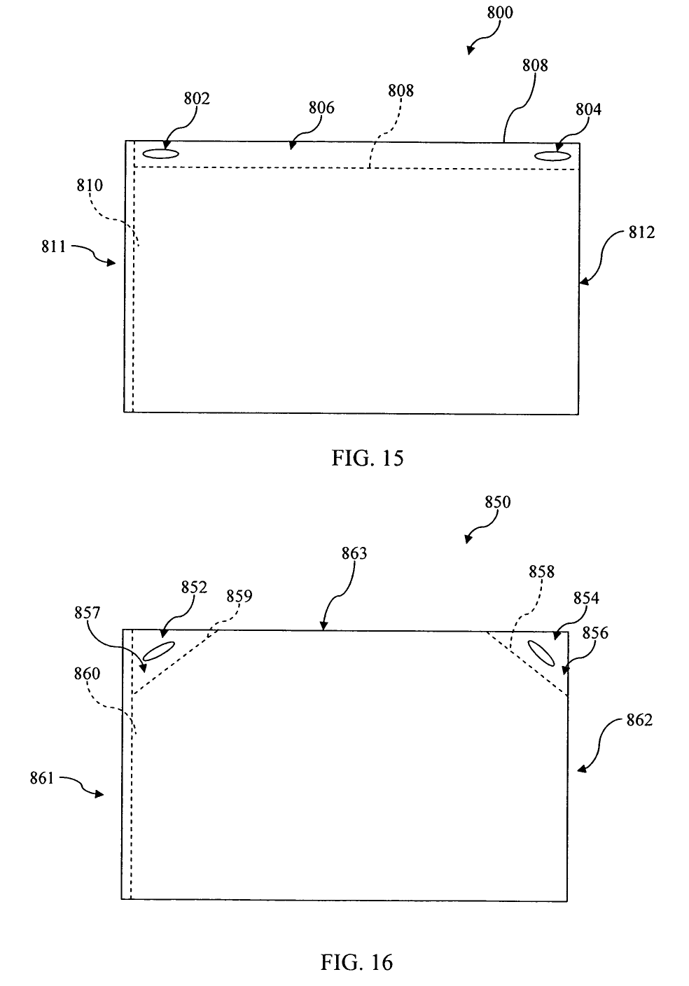

Referring to FIG. 15, a second embodiment 800 of a flexible container is shown. Flexible container 800 is generally similar to flexible container 106, except the flexible container 800 includes handles 802 and 804 to assist a user in pouring the resultant masonry composition from flexible container 800. Handles 802 and 804 are located in a first portion 806 of flexible container 800, which is illustratively shown along a side of flexible container 800. First portion 806 is separated from the remainder of the interior of flexible container 800 by a heat seal 808. As such, none of the resultant masonry component or dry mix component 102 and liquid component 104 may exit the interior of flexible container 800 through the openings provided in handles 802 and 804. In one embodiment, heat seal 808 is about 3 inches from an edge 813 of flexible container 800 and flexible container 800 is about 22 inches wide by about 34 inches tall.

Similar to flexible container 106, flexible container 800 is formed from a generally cylindrical wall of flexible material, such as a plastic bag. A bottom portion 811 of cylindrical wall is sealed together so that an interior of flexible container 800 is able to hold materials placed therein. The seal 810 is represented by a dashed line in FIG. 15. In one example, seal 810 is sealed about 0.5 inches from a lower edge of flexible container 800. In alternative embodiments, flexible container 800 has a bottom surface instead of a sealed edge. Flexible container 800 further includes an opening 812 to receive dry mix component 102 and liquid component 104 and to remove the resultant masonry component.

Referring to FIG. 16, a third embodiment 850 of a flexible container is shown. Flexible container 850 is generally similar to flexible container 106, except the flexible container 850 includes handles 852 and 854 to assist a user in pouring the resultant masonry composition from flexible container 850. Handles 852 and 854 are located in a first portion 856 and a second portion 857 of flexible container 850, which are illustratively shown adjacent first and second ends of a side 863 of flexible container 850. First portion 856 and second portion 857 are separated from the remainder of the interior of flexible container 850 by heat seals 858 and 859, respectively. As such, none of the resultant masonry component or dry mix component 102 and liquid component 104 may exit the interior of flexible container 850 through the openings provided in handles 852 and 854. In one embodiment, heat seals 858, 859 are about 6 inches in length and generally form about a 45 degree angle with side 863 of flexible container 800 and flexible container 800 is about 22 inches wide by about 34 inches tall.

Similar to flexible container 106, flexible container 850 is formed from a generally cylindrical wall of flexible material, such as a plastic bag. A bottom portion 861 of cylindrical wall is sealed together so that an interior of flexible container 850 is able to hold materials placed therein. The seal 860 is represented by a dashed line in FIG. 16. In one example, seal 860 is sealed about 0.5 inches from a lower edge of flexible container 850. In alternative embodiments, flexible container 850 has a bottom surface instead of a sealed edge. Flexible container 850 further includes an opening 862 to receive dry mix component 102 and liquid component 104 and to remove the resultant masonry component.

One or both of handles 802 and 804 of flexible container 800 and one or both of handles 852 and 854 of flexible container 850 may also be used to assist in the mixing process. By gripping the respective handle it is easier for the user to rock the respective flexible container to mix the dry mix component 102 and the liquid component 104.

If not all of the resultant masonry composition is required for the particular application, such as setting a post, the remaining portion of the resultant masonry composition may be left in flexible container 106 and discarded along with flexible container 106. Alternatively, the remaining portion of the resultant masonry composition may be cleaned out of flexible container 106 before it hardens allowing flexible container 106 to be reused at a later date. As stated above, flexible container 106 may be reused to make several batches of masonry composition without cleaning flexible container 106 as long as the batches of masonry composition are made within close temporal proximity of each other. In the case of cement compositions, flexible container 106 may be used to make six to seven successive batches of cement composition within about 45 to about 60 minutes without requiring cleaning of flexible container 106 between batches.

The above stated exemplary method does not require mixing tools, such as garden trowels, shovels, or hoes to produce the resultant masonry composition. Further, the above stated exemplary method does not require the use of a wheelbarrow, bucket, mortar box, mixing barrel, or other rigid container for mixing the dry mix component 102 and liquid component 104 therein.

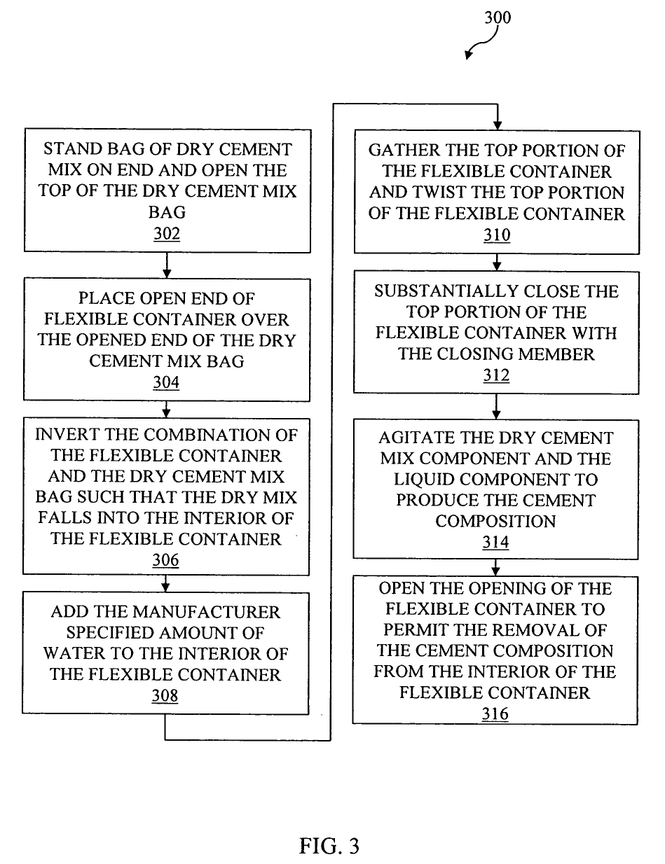

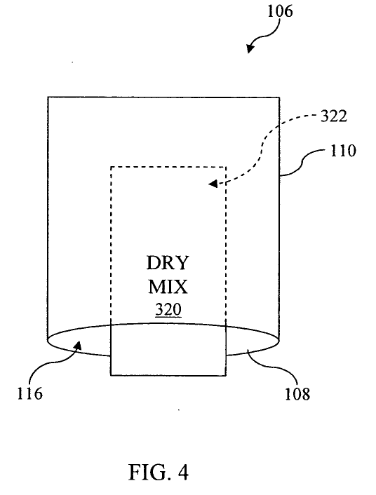

Referring to FIG. 3, an exemplary method 300 for mixing a bag of dry cement mix and water is shown. Portions of exemplary method 300 are illustratively shown in FIGS. 4-10. As represented by block 302, a bag of dry mix cement 320, such as an 80 pound bag, is stood on end and a top portion 322 of dry mix bag 320 is opened. As represented by block 304 and illustratively shown in FIG. 4, opening 108 of bag 110 is opened and placed over top portion 322 such that top portion 322 is received into interior 116. In one embodiment, opening 108 of bag 110 is opened and placed over top portion 322 such that substantially all of bag 1O is received into interior 116.

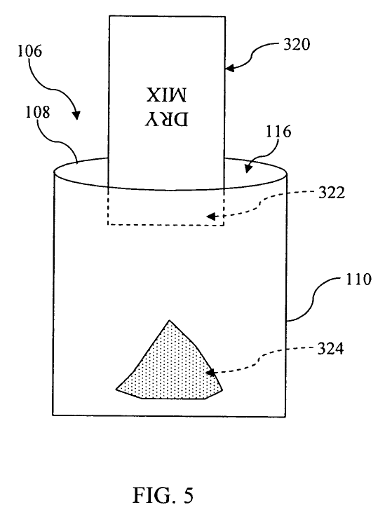

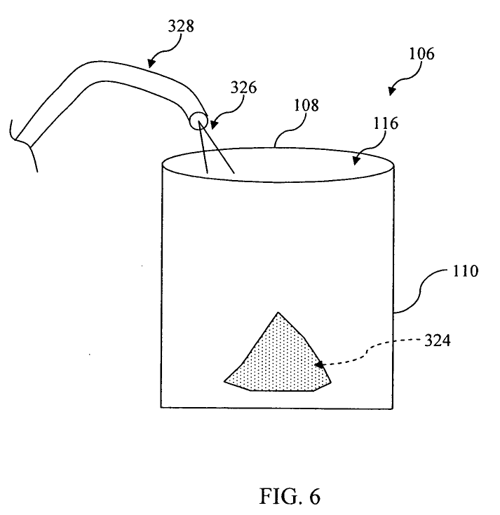

As represented by block 306 and illustratively shown in FIG. 5, the combination of dry mix bag 320 and bag 1O are inverted such that dry mix 324 exits dry mix bag 320 and is placed in interior 116 of bag 110. By placing top portion 322 of dry mix bag 320 inside bag 110 during the emptying of dry mix bag 320 the typical “cloud of dust” is avoided or reduced during the emptying of dry mix bag 320. As represented by block 308 and illustratively shown in FIG. 6, a liquid component 326, such as water from a hose 328 or from a pre-measured container (such as a pitcher or a jug), is added to interior 116 of bag 110. Preferably, the or about the manufacture's specified amount of water which is typically indicated on dry mix bag 320 is added to dry mix 324.

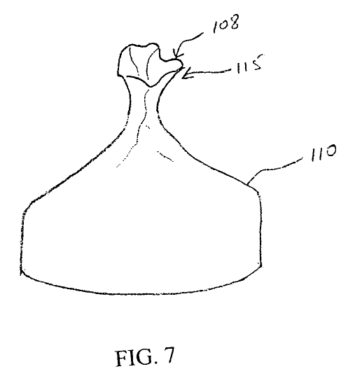

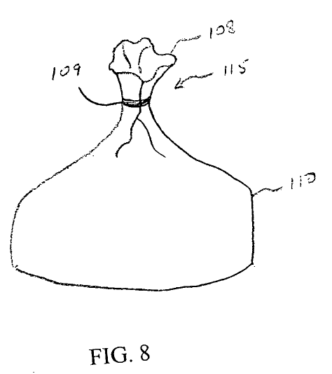

As represented by block 310 and illustratively shown in FIG. 7, top portion 115 of bag 110 is gathered together. Top portion 115 is further twisted to effectively generally close interior 116 of bag 110. As represented by block 312 and illustratively shown in FIG. 8, binding member 109 is positioned around gathered top portion 115 to substantially close the top portion of bag 110 and to prevent gathered portion 115 from opening.

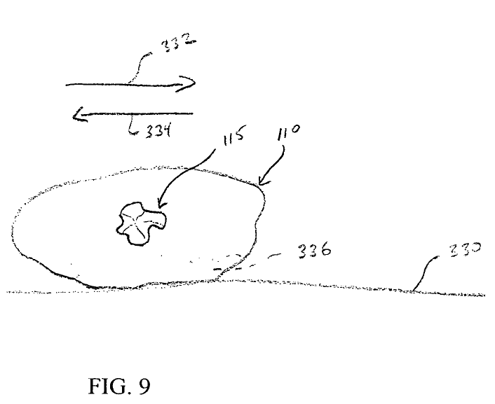

As represented by block 314 and illustratively shown in FIG. 9, dry cement mix 324 and water 326 are agitated to produce a cement composition 336. Referring to FIG. 9, in one example, bag 110 is rocked back and forth on ground 330 in directions 332, 334 to agitate dry cement mix 324 and water 326. As stated above in connection with FIG. 2, other agitation methods may be used in place of or in addition to the back and forth method shown in FIG. 9.

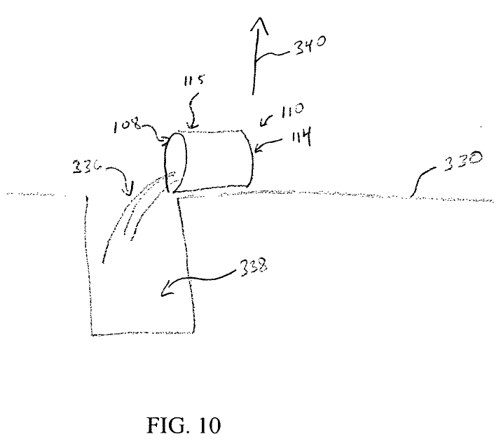

As represented by block 316 and illustratively shown in FIG. 10, binding member 109 is removed and gathered portion 115 is opened such that cement composition 336 may be removed from interior 116 of bag 110. As shown in FIG. 10, cement composition 336 is placed into a hole 338 in ground 330, such as a hole for a post (not shown). Opening 108 of bag 110 is positioned near or over hole 338 and lower portion 114 of bag 110 is raised in direction 340 to expel cement composition 336 from bag 110.

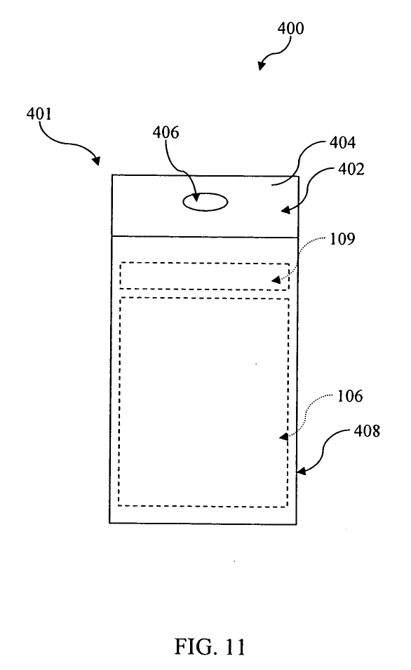

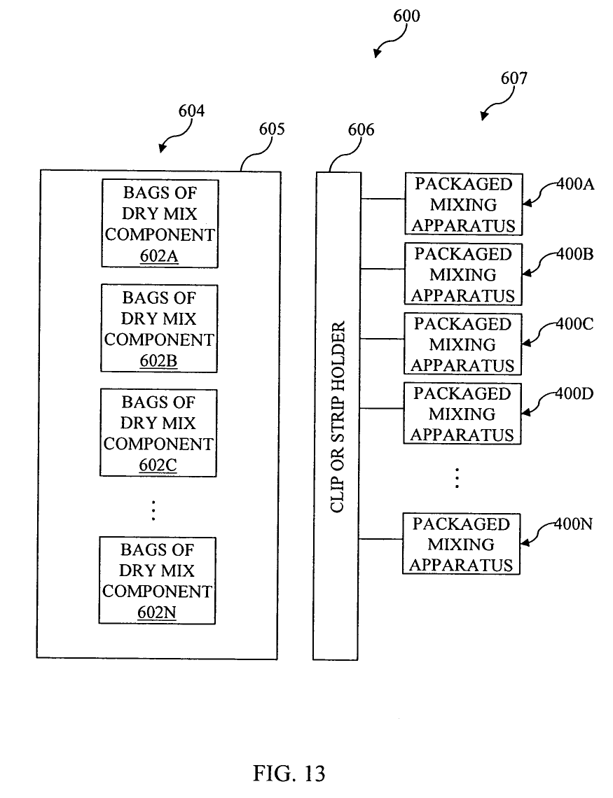

Referring to FIG. 11, apparatus 100 is shown in a packaged form 400. Packaged form 400 includes a holder 401. Holder 401 includes an upper portion 402 having a front face 404 and a rear face (not shown). Front face 404 and the rear face include areas for various indicia including trademark information, contact information, retail information such as bar codes, directions for use of apparatus 100 such as exemplary methods 200 or 300, and warnings, such as suffocation warnings Upper portion 402 also includes an aperture 406 to facilitate packaged form 400 being secured to a display clip strip, such as strip holder 604 in FIG. 13.

Holder 401 also includes a lower portion 408 configured to hold a collapsed flexible container 106 and a binding member 109. Lower portion 408 in one embodiment is a transparent bag and collapsed flexible container 106 and binding member 109 are placed into the interior of the bag. Flexible container 106 is collapsed in one embodiment by folding flexible container 106 to fit within lower portion 408. By packaging flexible container 106 in its collapsed form, shelf space is conserved.

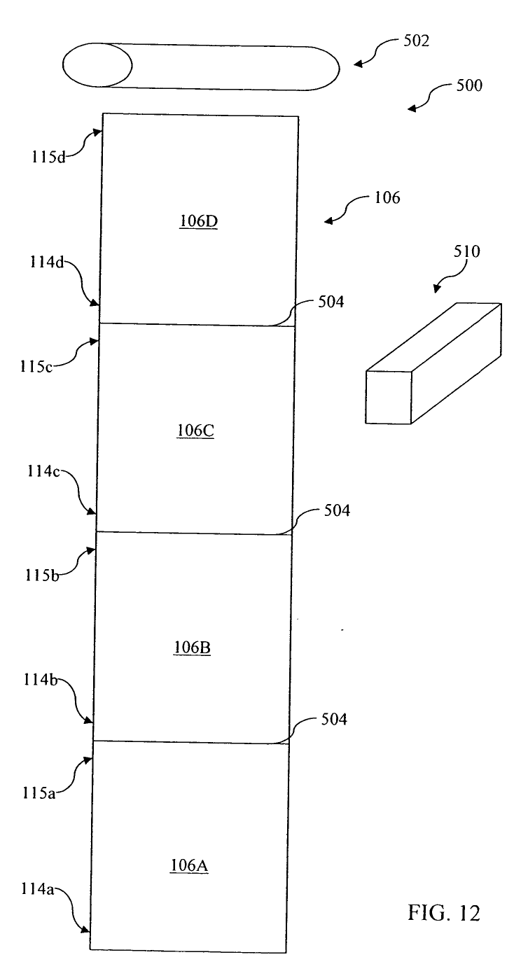

Referring to FIG. 12, a plurality of flexible containers 106a-d of apparatus 100 are shown in packaged form 500 wherein flexible containers 106a-d are rolled onto a roll 502 (flexible containers 106a-d are shown unrolled and spaced apart from roll 502 for illustrative purposes). Flexible containers 106a-d form a sheet 504 consisting of individual flexible containers attached to one other. A lower portion 114b of flexible container 106b is attached to upper portion 115a of flexible container 106a. The connection between lower portion 114b and upper portion 115a is configured to permit the easy separation of flexible containers 106a and 106b. In one example, the connection is perforated.

Packaged form 500 further includes one or more binding members 109 packaged therewith. In one example, packaged form 500 includes about 12 flexible containers 106. In another example, packaged form 500 includes about 24 flexible containers 106. In one embodiment, the roll of flexible containers 106a-d and the binding members are packaged in a box or carton 510.

Referring to FIG. 13, an exemplary placement 600 of packaged mixing apparatus 400 and packaged bags 602 of dry mix masonry components within a store environment is shown. A plurality of packaged bags 602 of dry mix masonry components 102 are displayed at a display location 604, such as a shelf 605 or a pallet. At a display location 607 which is proximate to the plurality of packaged bags 602 of dry mix masonry components, a plurality of packaged mixing apparatus 400 are provided attached to a strip holder 606, such as a clip strip holder. In one example, strip holder 606 may hold up to 12 packaged mixing apparatus 400. The relatively small size of packaged mixing apparatus 400 reduces the space required to display the packaged mixing apparatus 400 proximate to packaged bags 602 of dry mix masonry components.

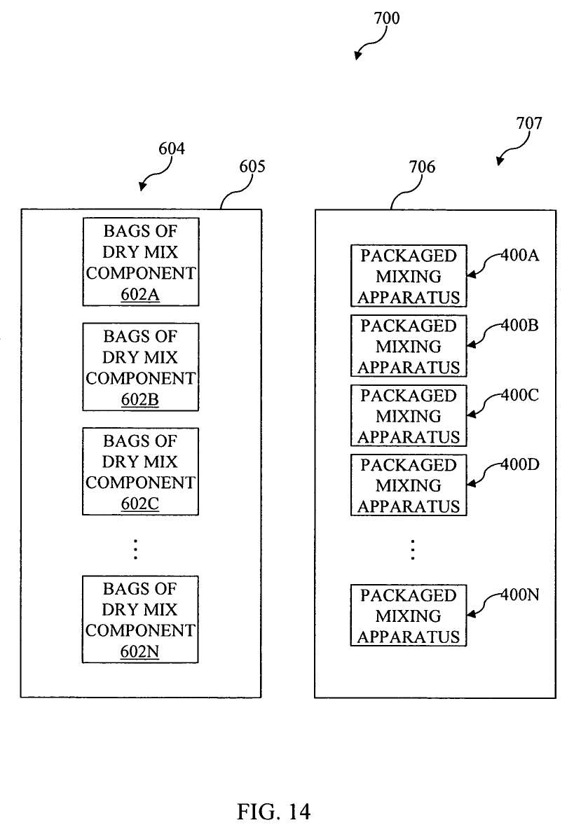

Referring to FIG. 14, an exemplary placement 600 of packaged mixing apparatus 400 and packaged bags 602 of dry mix masonry components within a store environment is shown. Bags 602 are again displayed at display location 604, such as a shelf 605 or a pallet. At a display location 707 which is proximate to the plurality of packaged bags 602 of dry mix masonry components, a plurality of packaged mixing apparatus 400 are provided attached in a display pack or carton 706. Pack 706 may be displayed on a counter (not shown) or on a shelf (not shown). In one example, pack 706 may hold up to 24 packaged mixing apparatus 400. Again, the relatively small size of packaged mixing apparatus 400 reduces the space required to display the packaged mixing apparatus 400 proximate to packaged bags 602 of dry mix masonry components.

In another embodiment, the roll of flexible containers 106 shown unrolled in FIG. 12 is placed in its respective box or carton and are displayed at display location 707 proximate to display location 706 which contains the plurality of bags of dry mix components 102.

Although the invention has been described in detail with reference to certain preferred embodiments, variations and modifications exist within the spirit and scope of the invention as described and defined in the following claims.

1. A method of mixing a dry mix masonry component and a liquid component to produce a masonry composition, the method comprising the steps of
providing a flexible container having an interior, an exterior, and an opening sized to receive the dry mix masonry component and the liquid component;
placing the dry mix masonry component and the liquid component into the interior of the flexible container through the opening, the dry mix masonry component and the liquid component being able to mix together;
substantially closing the opening of the flexible container to retain the dry mix masonry component and the liquid component within the interior of the flexible container;
agitating the dry mix masonry component and the liquid component to produce the masonry composition from the dry mix masonry component and the liquid component; and
opening the opening of the flexible container to permit the removal of the masonry composition from the interior of the flexible container.

2. The method of claim 1, wherein the step of placing the dry mix masonry component and the liquid component into the interior of the flexible container through the opening comprises the steps of:
standing a prepackaged bag containing the dry mix masonry component on end and opening at least a portion of a top of the bag;
introducing the opened top of the bag into the interior of the flexible container through the opening of the flexible container;
inverting the combination of the flexible container and the bag so that the dry mix masonry component exits the bag leaving an empty bag;
removing the empty bag from the interior of the flexible container; and
placing the liquid component into the interior of the flexible container.

3. The method of claim 1, wherein the step of agitating the dry mix masonry component and the liquid component is accomplished by agitating the dry mix masonry component and the liquid component from the exterior of the flexible container.

4. The method of claim 3, wherein the flexible container is at least semi-transparent so that an observer may visually determine the completeness of the mixing of the dry mix masonry component and the liquid component.

5. The method of claim 1, wherein the masonry composition is removed from the flexible container by placing the opening proximate to the location that the masonry composition is desired and raising the portion of the flexible container distal from the opening such that the masonry composition slides out of the flexible container.

6. The method of claim 1, wherein the step of substantially closing the opening of the flexible container to retain the dry mix masonry component and the liquid component comprises the steps of:
gathering a portion of the flexible container together, the portion being proximate to the opening;
placing a binding member on the exterior of the flexible container about the gathered portion; and
holding the gathered portion with the binding member.

7. The method of claim 1, wherein the step of agitating the dry mix masonry component and the liquid component comprises at least one of the steps of:
rolling the flexible container on the ground; and
kneading the dry mix masonry component and the liquid component.

8. The method of claim 1, wherein the flexible container has a sufficient volume to receive about eighty pounds of the dry mix masonry component from a bag containing the dry mix masonry component and wherein the flexible container has a wall thickness of about 0.007 inches.

9. The method of claim 8, wherein the flexible container has a width of about 22 inches and has a height of about 34 inches.

10. A method of producing multiple batches of a masonry composition, each batch produced by mixing a dry mix masonry component and a liquid component, the method comprising the steps of
providing a reusable flexible container having an open end;
producing a first batch of masonry composition from a first dry mix masonry component and a first liquid component including the steps of
placing the first dry mix masonry component and the first liquid component into an interior of the flexible container through the open end of the flexible container;
substantially closing the open end of the flexible container;
agitating the first dry mix component and the first liquid component to produce the first batch of masonry composition; and
opening the open end of the flexible container to permit the removal of the first batch of masonry composition from the interior of the flexible container; and
producing a second batch of masonry composition generally directly following the removal of the first batch of masonry composition from the flexible container, the second batch of masonry composition being produced from a second dry mix masonry component and a second liquid component including the steps of
placing the second dry mix masonry component and the second liquid component into the interior of the flexible container through the open end;
substantially closing the open end of the flexible container;
agitating the second dry mix component and the second liquid component to produce the second batch of masonry composition; and
opening the open end of the flexible container to permit the removal of the second batch of masonry composition from the interior of the flexible container.

11. The method of claim 10, wherein the step of placing the respective dry mix masonry component of the first and second dry mix masonry components and the respective liquid component of the first and second liquid components into the interior of the flexible container through the opening comprises the steps of:
standing a prepackaged bag containing the respective dry mix masonry component on end and opening at least a portion of a top of the bag;
introducing the opened top of the bag into the interior of the flexible container through the opening of the flexible container;
inverting the combination of the flexible container and the bag so that the respective dry mix masonry component exits the bag leaving an empty bag;
removing the empty bag from the interior of the flexible container; and
placing the respective liquid component into the interior of the flexible container.

12. The method of claim 10, wherein the step of agitating the respective dry mix masonry component of the first and the second dry mix masonry components and the respective liquid component of the first and second liquid components is accomplished by agitating the respective dry mix masonry component and the respective liquid component from the exterior of the flexible container.

13. The method of claim 12, wherein the flexible container is at least semi-transparent so that an observer may visually determine the completeness of the mixing of the respective dry mix masonry component and the respective liquid component.

14. The method of claim 12, wherein the step of substantially closing the opening of the flexible container to retain the respective dry mix masonry component and the respective liquid component comprises the steps of:
gathering a portion of the flexible container together, the portion being proximate to the opening;
placing a binding member on the exterior of the flexible container about the gathered portion; and
holding the gathered portion with the binding member.

15. A method for promoting the sale of masonry related products, the method comprising the steps of:
positioning a plurality of prepackaged dry mix masonry bags at a first display location, each of the prepackaged dry mix masonry bags containing a dry mix masonry component being configured to produce a masonry composition when thoroughly mixed with a liquid component;
positioning at a second display location proximate to the first display location, a plurality of prepackaged mixing apparatus configured for use with the dry mix masonry component of the prepackaged dry mix masonry bags, each prepackaged mixing apparatus including an empty flexible container having an open end and a binding member and each prepackaged mixing apparatus being configured to produce a batch of masonry composition.

16. The method of claim 15, wherein each of the prepackaged mixing apparatus are configured to produce a batch of masonry composition by:
receiving through the open end of the flexible container into an interior of the flexible container at least a portion of the dry mix masonry component of one of the prepackaged dry mix masonry bags and a corresponding amount of the liquid component;
substantially closing the open end of the flexible container with the binding member;
mixing the dry mix masonry component and the liquid component within the flexible container to produce a first batch of the masonry composition; and
removing the binding member to permit the removal of the masonry composition from the flexible container.

17. The method of claim 16, wherein the step of receiving through the open end of the flexible container into an interior of the flexible container at least a portion of the dry mix masonry component of one of the prepackaged dry mix masonry bags and a corresponding amount of the liquid component comprises the steps of:
standing the prepackaged dry mix masonry bag on end and opening at least a portion of a top of the bag;
introducing the opened top of the bag into the interior of the flexible container through the open end of the flexible container;
inverting the combination of the flexible container and the bag such that the dry mix masonry component exits the bag leaving an empty bag;
removing the empty bag from the interior of the flexible container; and
placing the corresponding amount of the liquid component into the interior of the flexible container.

18. The method of claim 16, wherein the step of mixing the dry mix masonry component and the liquid component within the flexible container to produce a first batch of the masonry composition is accomplished by agitating the dry mix masonry component and the liquid component from the exterior of the flexible container.

19. The method of claim 18, wherein the flexible container is at least semi-transparent such that an observer may visually determine the completeness of the mixing of the dry mix masonry component and the liquid component.

20. The method of claim 15, wherein each of the prepackaged mixing apparatus includes a holder having a lower portion and an upper portion, the lower portion configured to receive the empty flexible container and the binding member, the empty flexible container being folded prior to being received by the lower portion and the upper portion including a face having a location for indicia, the prepackaged mixing apparatus being coupled to a clip strip holder.
